(19) United States
(12) Patent Application Publication
(10) Pub. No.: US 2024/0222676 A1
(43) Pub. Date: Jul. 4, 2024

(54) IONICALLY CONDUCTIVE THIN FILM COMPOSITE MEMBRANES FOR ENERGY STORAGE APPLICATIONS

(71) Applicant: UOP LLC, Des Plaines, IL (US)

(72) Inventors: Chunqing Liu, Arlington Heights, IL (US); Michael G. Baddeloo, Northbrook, IL (US); Hunter D. Smith, Chicago, IL (US); Jinfeng Wu, Kildeer, IL (US)

(21) Appl. No.: 18/462,617

(22) Filed: Sep. 7, 2023

Related U.S. Application Data
(60) Provisional application No. 63/477,591, filed on Dec. 29, 2022.

(51) Int. Cl. H01M 8/18; H01M 8/1044; H01M 8/1048; H01M 8/1053; H01M 8/1067

(52) U.S. Cl. CPC H01M 8/188; H01M 8/1044; H01M 8/1048; H01M 8/1053; H01M 8/1067

(57) ABSTRACT

An ionically conductive thin film composite (TFC) membrane is described. The low cost, high performance TFC membrane comprises a first micropous support membrane, a hydrophilic ionomeric polymer coating layer on a first surface of the microporous support membrane, and a second microporous support membrane on the surface of the hydrophilic ionomeric polymer coating layer opposite the first microporous support membrane. The hydrophilic ionomeric polymer coating layer is ionically conductive. The ionomeric polymer can also be present in the micropores of the first microporous support membrane. Methods of making the TFC membranes and redox flow battery systems incorporating the TFC membranes are also described.

### RELATED APPLICATIONS

This application claims priority to U.S. Provisional Patent Application Ser. No. 63/477,591, filed on Dec. 29, 2022, the entirety of which is incorporated herein by reference.

### BACKGROUND OF THE INVENTION

Energy storage systems have played a key role in harvesting energy from various sources. The energy storage systems can be used to store energy and convert it for use in many different applications, such as building, transportation, utility, and industry. A variety of energy storage systems have been used commercially, and new systems are currently being developed. Energy storage types can be categorized as electrochemical and battery, thermal, thermochemical, flywheel, compressed air, pumped hydropower, magnetic, biological, chemical and hydrogen energy storages. The development of cost-effective and eco-friendly energy storage systems is needed to solve energy crisis and to overcome the mismatch between generation and end use.

Renewable energy sources, such as wind and solar power, have transient characteristics, which require energy storage. Renewable energy storage systems such as redox flow batteries (RFBs) have attracted significant attention for electricity grid, electric vehicles, and other large-scale stationary applications. RFB is an electrochemical energy storage system that reversibly converts chemical energy directly to electricity. The conversion of electricity via water electrolysis into hydrogen as an energy carrier without generation of carbon monoxide or dioxide as byproducts enables a coupling of the electricity, chemical, mobility, and heating sectors. Water electrolysis produces high quality hydrogen by electrochemical splitting of water into hydrogen and oxygen. Water electrolysis has zero carbon footprint when the process is operated by renewable power sources, such as wind, solar, or geothermal energy. The main water electrolysis technologies include alkaline electrolysis, polymer electrolyte membrane (PEM) electrolysis, and solid oxide electrolysis. PEM water electrolysis is one of the favorable methods for conversion of renewable energy to high purity hydrogen with the advantages of compact design, high current density, high efficiency, fast response, small footprint, lower temperature (20-90° C.) operation, and high purity oxygen byproduct.

RFBs are composed of two tanks filled with active materials comprising metal ions that may be in different valance states, two circulation pumps, and a flow cell with a separation membrane. The separation membrane is located between the anode and the cathode and is used to separate the anolyte and the catholyte, as well as to utilize the current circuit by allowing the transfer of balancing ions. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high cost vanadium and an expensive membrane. All-iron redox flow batteries (IFB) are particularly attractive for grid scale storage applications due to the use of low cost iron, salt, and water as the electrolyte.

The membrane is one of the key materials that make up a battery or electrolysis cell as a key driver for safety and performance. Some important properties for membranes for flow batteries, fuel cells, and membrane electrolysis include high conductivity, high ionic permeability (porosity, pore size and pore size distribution), high ionic exchange capacity (for ion-exchange membrane), high ionic/electrolyte selectivity (low permeability/crossover to electrolytes), low price (less than $150-200/m²), low area resistance to minimize efficiency loss resulting from ohmic polarization, high resistance to oxidizing and reducing conditions, chemically inert to a wide pH range, high thermal stability together with high proton conductivity (greater than or equal to 120° C. for fuel cell), high proton conductivity at high T without H₂O, high proton conductivity at high T with maintained high RH, and high mechanical strength (thickness, low swelling).

The two main types of membranes for redox flow battery, fuel cell, and electrolysis applications are polymeric ion-exchange membranes and microporous separators. The polymeric ion-exchange membranes can be cation-exchange membranes comprising —SO₃⁻, —COO⁻, —PO₃²⁻, —PO₃H⁻, or —C₆H₄O⁻ cation exchange functional groups, anion-exchange membranes comprising —NH₃⁺, —NRH₂⁺, —NR₂H⁺, or —NR₃⁺ anion exchange functional groups, or bipolar membranes comprising both cation-exchange and anion-exchange polymers. The polymers for the preparation of ion-exchange membranes can be perfluorinated ionomers such as Nafion®, Flemion®, and NEOSEPTA®-F, partially fluorinated polymers, non-fluorinated hydrocarbon polymers, non-fluorinated polymers with aromatic backbone, or acid-base blends. In general, perfluorosulfonic acid (PFSA)-based membranes, such as Nafion® and Flemion®, are used in vanadium redox flow battery (VRFB) systems due to their oxidation stability, good ion conductivity, unique morphology, mechanical strength, and high electrochemical performance. However, these membranes have low balancing ions/electrolyte metal ion selectivity, and high electrolyte metal ion crossover which causes capacity decay in VRFBs, and they are expensive.

The microporous and nanoporous membrane separators can be inert microporous/nanoporous polymeric membrane separators, inert non-woven porous films, or polymer/inorganic material coated/impregnated separators. The inert microporous/nanoporous polymeric membrane separators can be microporous polyethylene (PE), polypropylene (PP), PE/PP, or composite inorganic/PE/PP membrane, inert non-woven porous films, non-woven PE, PP, polyamide (PA), polytetrafluoroethylene (PTFE), polyvinyl chloride (PVC), polyvinylidene fluoride (PVDF), polyethylene terephalate (PET), or polyester porous film. For example, microporous Daramic® and Celgard® membrane separators made from PE or PP polymer are commercially available. They normally have high ionic conductivity, but also high electrolyte cross-over for RFB applications.

Despite the significant research efforts, the wide adoption of redox flow batteries for grid energy storage applications is still a challenge.

Therefore, there is a need for a reliable, high-performance (low electrolyte or gas crossover and excellent conductivity), low-cost membrane for energy storage applications such as redox flow battery, fuel cell, and electrolysis applications.

### DESCRIPTION OF THE INVENTION

Low cost high performance ionically conductive thin film composite (TFC) membrane for energy storage applications such as redox flow battery, fuel cell, and electrolysis applications were developed previously. These TFC membranes provide an ionically conductive membrane that combines a size-exclusion ion-conducting separation mechanism derived from the hydrophilic property of the polymer with an ion-exchange ion-conducting separation mechanism derived from the ionomeric property of the polymer. The ionically conductive TFC membranes exhibit improved performance compared to traditional polymeric ion-exchange membranes with ion-exchange ion-conducting separation mechanism and microporous membrane separators with size-exclusion ion-conducting separation mechanism. The TFC membranes comprise a micropous support membrane, and a hydrophilic ionomeric polymer coating layer on a surface of the microporous support membrane. The ionomeric polymer can also be present in the micropores of the support membrane. The hydrophilic ionomeric polymer coating layer is ionically conductive, which means the hydrophilic ionomeric polymer coating layer has ionic conductivity and can transport the charge-carrying ions, such as protons or chloride ion (Cl⁻), from one side of the membrane to the other side of the membrane to maintain the electric circuit. The electrical balance is achieved by the transport of charge-carrying ions (such as protons, chloride ions, potassium ions, or sodium ions in all iron redox flow battery system) in the electrolytes across a membrane comprising a hydrophilic ionomeric polymer coating layer during the operation of the battery cell.

The ionic conductivity (6) of the membrane is a measure of its ability to conduct charge-carrying ions, and the measurement unit for conductivity is Siemens per meter (S/m). The ionic conductivity (6) of the ionically conductive TFC membrane is measured by determining the resistance (R) of the membrane between two electrodes separated by a fixed distance. The resistance is determined by electrochemical impedance spectroscopy (EIS) and the measurement unit for the resistance is Ohm (Ω). The membrane area specific resistance (RA) is the product of the resistance of the membrane (R) and the membrane active area (A) and the measurement unit for the membrane area specific resistance is (Ω·cm²). The membrane ionic conductivity (o, S/cm) is proportional to the membrane thickness (L, cm) and inversely proportional to the membrane area specific resistance (RA, Ω·cm²). The performance of the ionically conductive TFC membrane for RFB applications is evaluated by several parameters including membrane solubility and stability in the electrolytes, area specific resistance, numbers of battery charge/discharge cycling, electrolyte crossover through the membrane, voltage efficiency (VE), coulombic efficiency (CE), and energy efficiency (EE) of the RFB cell. CE is the ratio of a cell's discharge capacity divided by its charge capacity. A higher CE, indicating a lower capacity loss, is mainly due to the lower rate of crossover of electrolyte ions, such as ferric and ferrous ions, in the iron redox flow battery system. VE is defined as the ratio of a cell's mean discharge voltage divided by its mean charge voltage (See M. Skyllas-Kazacos, C. Menictas, and T. Lim, Chapter 12 on Redox Flow Batteries for Medium- to Large-Scale Energy Storage in Electricity Transmission, Distribution and Storage Systems, A volume in Woodhead Publishing Series in Energy, 2013). A higher VE, indicating a higher ionic conductivity, is mainly due to the low area specific resistance of the membrane. EE is the product of VE and CE and is an indicator of energy loss in charge-discharge processes. EE is a key parameter to evaluate an energy storage system.

The incorporation of the low cost high performance hydrophilic ionomeric polymer into the TFC membrane provided an ionically conductive membrane that combined a size-exclusion ion-conducting separation mechanism derived from the hydrophilic property of the polymer with an ion-exchange ion-conducting separation mechanism derived from the ionomeric property of the polymer. Therefore, the ionically conductive TFC membrane exhibited improved performance compared to traditional polymeric ion-exchange membranes with ion-exchange ion-conducting separation mechanism and microporous membrane separators with size-exclusion ion-conducting separation mechanism for energy storage applications such as for redox flow battery applications. The ionically conductive TFC membrane showed excellent membrane stability in the electrolytes, low area specific resistance, high numbers of battery charge/discharge cycles, low electrolyte crossover through the membrane, high VE, CE, and EE for redox flow battery applications.

However, it was discovered that the hydrophilic ionomeric polymer coating layer on the surface of the microporous support membrane near the battery cell sealing area could be damaged during stack assembly. The coating layer can also potentially be damaged by the fibers on the carbon felt electrode during battery stack assembly or battery operation. This damage if it occurs may result in a drop in server performance.

In order to avoid this potential damage, a new low cost high performance ionically conductive TFC membrane has been developed. The new TFC membranes comprise a first micropous support membrane, a hydrophilic ionomeric polymer coating layer on a surface of the first microporous support membrane, and a second microporous support membrane on the surface of the hydrophilic ionomeric polymer coating layer opposite the first microporous support membrane. This forms a sandwich structure in which the hydrophilic ionomeric polymer coating layer is positioned between the two microporous support membranes and is protected by them. The second microporous support membrane may be adhered to the second surface of the hydrophilic ionomeric polymer coating layer. Alternatively, the second microporous support membrane can be placed next to the hydrophilic ionomeric polymer coating layer without being adhered to it.

The hydrophilic ionomeric polymer comprises a hydrophilic ionomeric polymer or a cross-linked hydrophilic ionomeric polymer comprising repeat units of both electrically neutral repeating units and a fraction of ionized functional groups such as —SO₃⁻, —COO⁻, —PO₃²⁻, —PO₃H⁻, —C₆H₄O⁻, —O₄B⁻, —NH₃⁺, —NRH₂⁺, —NR₂H⁺, —NR₃⁺, or —SR₂⁻. The hydrophilic ionomeric polymer contains high water affinity polar or charged functional groups such as —SO₃⁻, —COO⁻ or —NH₃⁺ group. The cross-linked hydrophilic polymer comprises a hydrophilic polymer complexed with a complexing agent such as polyphosphoric acid, boric acid, a metal ion, or a mixture thereof. The hydrophilic ionomeric polymer not only has high stability in an aqueous electrolyte solution due to its insolubility in the aqueous electrolyte solution, but also has high affinity to water and charge-carrying ions such as H₃O⁺ or Cl⁻ due to the hydrophilicity and ionomeric property of the polymer and therefore high ionic conductivity and low membrane specific area resistance.

The hydrophilic ionomeric polymer coating layer on the ionically conductive TFC membrane comprises a dense layer with a thickness typically in the range of about 1 micrometer to about 100 micrometers, or in the range of about 5 micrometers to about 50 micrometers. The dense hydrophilic ionomeric polymer coating layer forms very small nanopores with a pore size less than 0.5 nm in the presence of liquid water or water vapor, and in some cases combined with the existence of a cross-linked polymer structure via the complexing agent to control the swelling degree of the polymer, this results in high selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

Suitable hydrophilic ionomeric polymers include, but are not limited to, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer such as sodium alginate, potassium alginate, calcium alginate, ammonium alginate, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

Various types of polysaccharide polymers may be used, including, but not limited to, chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

In some embodiments, the hydrophilic ionomeric polymer is a polyphosphoric acid-complexed chitosan polymer, a polyphosphoric acid and metal ion-complexed chitosan polymer, a metal ion-complexed alginic acid polymer, or combinations thereof.

In some embodiments, the hydrophilic ionomeric polymer is a boric acid-complexed polyvinyl alcohol polymer, a boric acid-complexed alginic acid, or a blend of boric acid-complexed polyvinyl alcohol and alginic acid polymer.

In some embodiments, the metal ion complexing agent is ferric ion, ferrous ion, or vanadium ion.

In some embodiments, the hydrophilic ionomeric polymer is present in the micropores of the first microporous support membrane.

The first and second microporous support membrane should have good thermal stability (stable up to at least 100° C.), high aqueous and organic solution resistance (insoluble in aqueous and organic solutions) under low pH condition (e.g., pH less than 6), high resistance to oxidizing and reducing conditions (insoluble and no performance drop under oxidizing and reducing conditions), high mechanical strength (no dimensional change under the system operation conditions), as well as other factors dictated by the operating conditions for energy storage applications. The first and second microporous support membrane should be compatible with the cell chemistry and meet the mechanical demands of cell stacking or winding assembly operations. The microporous support membrane has high ionic conductivity but low selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

The first and second microporous support membranes can be made of the same material or different materials.

The polymers suitable for the preparation of the first and second microporous support membranes can be selected from, but not limited to, polyolefins such as polyethylene and polypropylene, a mixture of polyethylene and silica particles, a mixture of polypropylene and silica particles, polyamide such as Nylon 6 and Nylon 6,6, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof. These polymers provide a range of properties such as low cost, high stability in water and electrolytes under a wide range of pH, good mechanical stability, and ease of processability for membrane fabrication.

The first and second microporous support membranes can have a symmetric porous structure or an asymmetric porous structure. The asymmetric microporous support membrane can be formed by a phase inversion membrane fabrication approach followed by direct air drying, or by phase inversion followed by solvent exchange methods. The first and second microporous support membranes also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-1000 micrometers, or a range of 10-900 micrometers, or a range of 10-800 micrometers, or a range of 10-700 micrometers, or a range of 10-600 micrometers, or a range of 10-500 micrometers, or a range of 20-500 micrometers. The pore size of the microporous membrane can be in a range of 10 nanometers to 50 micrometers, or a range of 50 nanometers to 10 micrometers, or a range of 0.2 micrometers to 1 micrometer.

Another aspect of the invention are methods of making the TFC membrane. In one embodiment, the method comprises applying a layer of an aqueous solution comprising a hydrophilic ionomeric polymer to one surface of a first microporous support membrane; drying the coated membrane; optionally complexing the hydrophilic ionomeric polymer using a complexing agent to form a cross-linked hydrophilic ionomeric polymer; and applying a second microporous support membrane to the coated membrane on a surface opposite the first microporous support membrane.

In some embodiments, the coated membrane is dried before complexing the hydrophilic ionomeric polymer. In other embodiments, the coated membrane is dried after complexing the hydrophilic polymer. In other embodiments, the coated membrane is dried before complexing the hydrophilic ionomeric polymer and is dried again after complexing the hydrophilic polymer. The coated membrane may be dried for a time in a range of 5 min to 5 h, or 5 min to 4 h, or 5 min to 3 h, or 10 min to 2 h, or 30 min to 1 h at a temperature in a range of 40° C. to 100° C., or 40° C. to 80° C., or 55° C. to 65° C.

In some embodiments, the second microporous membrane is applied to the coated membrane after drying the coated membrane.

In some embodiments, the complexing agent is selected from polyphosphoric acid, boric acid, a metal ion selected from ferric ion, ferrous ion, or vanadium ion, or combinations thereof.

In some embodiments, complexing the hydrophilic ionomeric polymer comprises immersing the dried coated membrane in a second aqueous solution of polyphosphoric acid, boric acid, metal salt, hydrochloric acid, or combinations thereof.

In some embodiments, complexing the hydrophilic ionomeric polymer comprises complexing the dried coated membrane together with the second microporous support membrane with a complexing agent in situ in a redox flow battery cell.

In some embodiments, the aqueous solution comprises acetic acid or other inorganic or organic acids.

In some embodiments, the hydrophilic ionomeric polymer on the coated membrane is treated in an aqueous solution of hydrochloric acid before complexing the hydrophilic polymer.

In some embodiments, the hydrophilic polymer layer on the coated membrane is immersed in a second aqueous solution of polyphosphoric acid or boric acid for a time in a range of 5 min to 24 h, or 5 min to 12 h, or 5 min to 8 h, or 10 min to 5 h, or 30 min to 1 h, and then immersed in an aqueous metal salt or hydrochloric acid solution for a time in a range of 5 min to 24 h, or 5 min to 12 h, or 5 min to 8 h, or 10 min to 5 h, or 30 min to 1 h.

In other embodiments, the hydrophilic polymer is complexed in situ with a complexing agent in a negative electrolyte, a positive electrolyte, or both the negative electrolyte and the positive electrolyte in a redox flow battery cell.

In some embodiments, the hydrophilic ionomeric polymer comprises a polysaccharide polymer, a poly(acrylic acid) polymer, a poly(methacrylic acid), or combinations thereof.

In some embodiments, the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

Another aspect of the invention is a redox flow battery system. In one embodiments, the redox flow battery system comprises: at least one rechargeable cell comprising a positive electrolyte, a negative electrolyte, and an ionically conductive thin film composite (TFC) membrane positioned between the positive electrolyte and the negative electrolyte, wherein the TFC membrane comprises a first microporous support membrane, a hydrophilic ionomeric polymer coating layer on a first surface of the microporous support membrane, and a second microporous support membrane on a surface of the hydrophilic ionomeric polymer coating layer opposite the first microporous support membrane, wherein the hydrophilic ionomeric polymer coating layer is ionically conductive.

In some embodiments, the negative electrolyte, the positive electrolyte, or both the negative electrolyte and the positive electrolyte comprises a boric acid additive capable of complexing with a hydrophilic polymer on the surface of the first microporous support membrane to form a cross-linked hydrophilic ionomeric polymer coating layer.

In some embodiment, the negative electrolyte, the positive electrolyte, or both the negative electrolyte and the positive electrolyte comprises ferrous chloride.

In some embodiment, the positive electrolyte comprises ferrous chloride and hydrochloric acid.

In some embodiments, the hydrophilic ionomeric polymer coating layer is formed in situ by complexing a hydrophilic polymer on the surface of the first microporous support membrane with a complexing agent in the negative electrolyte, the positive electrolyte, or both the negative electrolyte and the positive electrolyte. This is typically done with the second microporous support membrane being present.

### EXAMPLES

The following examples are provided to illustrate one or more preferred embodiments of the invention but are not limited embodiments thereof. Numerous variations can be made to the following examples that lie within the scope of the invention.

### Comparative Example 1. Preparation of an Iron Flow Battery Cell Comprising Alginic Acid/Daramic® Thin Film Composite (TFC) Membrane (Abbreviated as AD-IFB)

An ion flow battery cell comprising an alginic acid/Daramic® thin-film composite (TFC) membrane, carbon felt positive and negative electrodes, positive electrolyte and negative electrolyte was prepared as the following:

A 9.0 wt % sodium alginate aqueous solution was prepared by dissolving sodium alginate polymer in deionized (DI) water. One surface of a Daramic® microporous support membrane purchased from Daramic, LLC was coated with a thin layer of the 9.0 wt % sodium alginate aqueous solution and dried at 60° C. for 2 h to form a sodium alginate layer on the surface of the Daramic® support membrane. The dried sodium alginate/Daramic® TFC membrane was assembled together with a carbon felt positive electrode, a carbon felt negative electrode, two plastic flow frames, two graphite bipolar plates, and two copper current collectors to form an iron flow battery cell. A positive electrolyte tank comprising a positive electrolyte and a negative electrolyte tank comprising a negative electrolyte were connected to the positive and negative side of the iron flow battery cell, respectively. The positive electrolyte was circulated in the battery cell for 2 h before the battery operation to form the final iron flow battery cell comprising alginic acid/Daramic® TFC membrane (abbreviated as AD-IFB).

### Example 1. Preparation of an Iron Flow Battery Cell Comprising Sandwich Daramic®/Alginic Acid/Daramic® TFC Membrane (Abbreviated as DAD-IFB)

An ion flow battery cell comprising a sandwich Daramic®/alginic acid/Daramic® TFC membrane, carbon felt positive and negative electrodes, positive electrolyte and negative electrolyte was prepared as the following:

A 9.0 wt % sodium alginate aqueous solution was prepared by dissolving sodium alginate polymer in deionized (DI) water. One surface of a Daramic® microporous support membrane purchased from Daramic, LLC was coated with a thin layer of the 9.0 wt % sodium alginate aqueous solution and dried at 60° C. for 2 h to form a sodium alginate layer on the surface of the Daramic® support membrane. A second Daramic® microporous support membrane was added to the surface of the dried sodium alginate coating layer to form the sandwich Daramic®/alginic acid/Daramic® TFC membrane. The membrane was assembled together with a carbon felt positive electrode, a carbon felt negative electrode, two plastic flow frames, two graphite bipolar plates, and two copper current collectors to form an iron flow battery cell. A positive electrolyte tank comprising a positive electrolyte and a negative electrolyte tank comprising a negative electrolyte were connected to the positive and negative side of the iron flow battery cell, respectively. The positive electrolyte was circulated in the battery cell for 2 h before the battery operation to form the final iron flow battery cell comprising sandwich Daramic®/alginic acid/Daramic® TFC membrane (abbreviated as DAD-IFB).

### Example 2. All-Iron Redox Flow Battery Performance Study on AD-IFB and DAD-IFB Batteries

The battery performance of the all-iron redox flow batteries AD-IFB as described in Comparative Example 1 and DAD-IFB as described in Example 1 were evaluated using Arbin RBT battery tester (Arbin Instruments, USA) at 40° C. Both batteries used the same electrolyte formula comprising a positive electrolyte solution and a negative electrolyte solution. Both the positive and negative electrolyte solutions comprised FeCl₂, NH₄Cl, HCl, and glycine in ultrapure water (18.2 MΩ·cm). The results show that the initial CE of DAD-IFB is about 2% higher than that of AD-IFB attributed to the addition of the second microporous support membrane, while the VE of DAD-IFB is lower than that of AD-IFB by approximate 2.8%. The initial overall performances (EE) of DAD-IFB and AD-IFB are comparable. However, more importantly, the long term tests reveal that the EE of DAD-IFB is much more stable than that achieved by AD-IFB. These results demonstrated that, for the new TFC membrane, the hydrophilic ionomeric polymer coating layer sandwiched between two microporous support membranes can be protected effectively from the destruction near the sealing area during stack assembly as well as the damage by the fibers on the carbon felt during stack assembly or battery operation.

### Specific Embodiments

While the following is described in conjunction with specific embodiments, it will be understood that this description is intended to illustrate and not limit the scope of the preceding description and the appended claims.

A first embodiment of the invention is a composition comprising a first microporous support membrane; a hydrophilic ionomeric polymer coating layer on a surface of the first microporous support membrane, the hydrophilic ionomeric polymer coating layer being ionically conductive; and a second microporous support membrane on a surface of the hydrophilic ionomeric polymer coating layer opposite the first microporous support membrane. An embodiment of the invention is one, any or all of prior embodiments in this paragraph up through the first embodiment in this paragraph wherein the hydrophilic ionomeric polymer comprises a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof. An embodiment of the invention is one, any or all of prior embodiments in this paragraph up through the first embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof. An embodiment of the invention is one, any or all of prior embodiments in this paragraph up through the first embodiment in this paragraph wherein metal ion is ferric ion, ferrous ion, or vanadium ion. An embodiment of the invention is one, any or all of prior embodiments in this paragraph up through the first embodiment in this paragraph wherein the hydrophilic ionomeric polymer is a polyphosphoric acid-complexed chitosan polymer, a polyphosphoric acid and metal ion-complexed chitosan polymer, a metal ion-complexed alginic acid polymer, a sodium alginate polymer, an alginic acid polymer, a hyaluronic acid polymer, or combinations thereof. An embodiment of the invention is one, any or all of prior embodiments in this paragraph up through the first embodiment in this paragraph wherein the metal ion is ferric ion, ferrous ion, or vanadium ion. An embodiment of the invention is one, any or all of prior embodiments in this paragraph up through the first embodiment in this paragraph wherein the hydrophilic ionomeric polymer is a boric acid-complexed polyvinyl alcohol polymer, a boric acid-complexed alginic acid, or a blend of boric acid-complexed polyvinyl alcohol and alginic acid polymer. An embodiment of the invention is one, any or all of prior embodiments in this paragraph up through the first embodiment in this paragraph wherein the first microporous support membrane or the second microporous support membrane or both comprises polyethylene, polypropylene, a mixture of polyethylene and silica particles, a mixture of polypropylene and silica particles, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof. An embodiment of the invention is one, any or all of prior embodiments in this paragraph up through the first embodiment in this paragraph wherein the hydrophilic ionomeric polymer is present in the micropores of the first microporous support membrane.

A second embodiment of the invention is a method of preparing an ionically conductive thin film composite (TFC) membrane comprising applying a layer of an aqueous solution comprising a hydrophilic ionomeric polymer to one surface of a first microporous support membrane; drying the coated membrane; optionally complexing the hydrophilic ionomeric polymer using a complexing agent to form a cross-linked hydrophilic ionomeric polymer; and applying a second microporous support membrane to the coated membrane on a surface opposite the first microporous support membrane. An embodiment of the invention is one, any or all of prior embodiments in this paragraph up through the second embodiment in this paragraph wherein the hydrophilic ionomeric polymer on the coated membrane is dried before complexing the hydrophilic ionomeric polymer. An embodiment of the invention is one, any or all of prior embodiments in this paragraph up through the second embodiment in this paragraph wherein the second microporous support membrane is applied to the coated membrane after drying the coated membrane. An embodiment of the invention is one, any or all of prior embodiments in this paragraph up through the second embodiment in this paragraph wherein the complexing agent is selected from polyphosphoric acid, boric acid, a metal ion selected from ferric ion, ferrous ion, or vanadium ion, or combinations thereof. An embodiment of the invention is one, any or all of prior embodiments in this paragraph up through the second embodiment in this paragraph wherein complexing the hydrophilic ionomeric polymer comprises immersing the dried coated membrane in a second aqueous solution of polyphosphoric acid, boric acid, metal salt, hydrochloric acid, or combinations thereof. An embodiment of the invention is one, any or all of prior embodiments in this paragraph up through the second embodiment in this paragraph wherein complexing the hydrophilic ionomeric polymer comprises complexing the dried coated membrane together with the second microporous support membrane with a complexing agent in situ in a redox flow battery cell. An embodiment of the invention is one, any or all of prior embodiments in this paragraph up through the second embodiment in this paragraph wherein the hydrophilic ionomeric polymer comprises a polysaccharide polymer, a poly(acrylic acid) polymer, a poly(methacrylic acid), or combinations thereof. An embodiment of the invention is one, any or all of prior embodiments in this paragraph up through the second embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

A third embodiment of the invention is a system, comprising at least one rechargeable cell comprising a positive electrolyte, a negative electrolyte, and an ionically conductive thin film composite (TFC) membrane positioned between the positive electrolyte and the negative electrolyte, wherein the TFC membrane comprises a first microporous support membrane, a hydrophilic ionomeric polymer coating layer on a surface of the first microporous support membrane, and a second microporous support membrane on a surface of the hydrophilic ionomeric polymer coating layer opposite the first microporous support membrane, wherein the hydrophilic ionomeric polymer coating layer is ionically conductive. An embodiment of the invention is one, any or all of prior embodiments in this paragraph up through the third embodiment in this paragraph wherein the negative electrolyte, the positive electrolyte, or both the negative electrolyte and the positive electrolyte comprises a boric acid additive capable of complexing with a hydrophilic ionomeric polymer on the surface of the microporous support membrane to form a cross-linked hydrophilic ionomeric polymer coating layer. An embodiment of the invention is one, any or all of prior embodiments in this paragraph up through the third embodiment in this paragraph wherein the hydrophilic ionomeric polymer coating layer is formed in situ by complexing a hydrophilic ionomeric polymer on the surface of the first microporous support membrane with a complexing agent in the negative electrolyte, the positive electrolyte, or both the negative electrolyte and the positive electr

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An ionically conductive thin film composite (TFC) membrane comprising:
a first microporous support membrane;
a hydrophilic ionomeric polymer coating layer on a surface of the first microporous support membrane, the hydrophilic ionomeric polymer coating layer being ionically conductive; and
a second microporous support membrane on a surface of the hydrophilic ionomeric polymer coating layer opposite the first microporous support membrane.

2. The TFC membrane of claim 1 wherein the hydrophilic ionomeric polymer comprises a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

3. The TFC membrane of claim 2 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

4. The TFC membrane of claim 2 wherein metal ion is ferric ion, ferrous ion, or vanadium ion.

5. The TFC membrane of claim 1 wherein the hydrophilic ionomeric polymer is a polyphosphoric acid-complexed chitosan polymer, a polyphosphoric acid and metal ion-complexed chitosan polymer, a metal ion-complexed alginic acid polymer, a sodium alginate polymer, an alginic acid polymer, a hyaluronic acid polymer, or combinations thereof.

6. The TFC membrane of claim 5 wherein the metal ion is ferric ion, ferrous ion, or vanadium ion.

7. The TFC membrane of claim 1 wherein the hydrophilic ionomeric polymer is a boric acid-complexed polyvinyl alcohol polymer, a boric acid-complexed alginic acid, or a blend of boric acid-complexed polyvinyl alcohol and alginic acid polymer.

8. The TFC membrane of claim 1 wherein the first microporous support membrane or the second microporous support membrane or both comprises polyethylene, polypropylene, a mixture of polyethylene and silica particles, a mixture of polypropylene and silica particles, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof.

9. The TFC membrane of claim 1 wherein the hydrophilic ionomeric polymer is present in the micropores of the first microporous support membrane.

10. A method of preparing an ionically conductive thin film composite (TFC) membrane comprising:
applying a layer of an aqueous solution comprising a hydrophilic ionomeric polymer to one surface of a first microporous support membrane;
drying the coated membrane;
optionally complexing the hydrophilic ionomeric polymer using a complexing agent to form a cross-linked hydrophilic ionomeric polymer; and
applying a second microporous support membrane to the coated membrane on a surface opposite the first microporous support membrane.

11. The method of claim 10 wherein the hydrophilic ionomeric polymer on the coated membrane is dried before complexing the hydrophilic ionomeric polymer.

12. The method of claim 10 wherein the second microporous support membrane is applied to the coated membrane after drying the coated membrane.

13. The method of claim 10 wherein the complexing agent is selected from polyphosphoric acid, boric acid, a metal ion selected from ferric ion, ferrous ion, or vanadium ion, or combinations thereof.

14. The method of claim 10 wherein complexing the hydrophilic ionomeric polymer comprises immersing the dried coated membrane in a second aqueous solution of polyphosphoric acid, boric acid, metal salt, hydrochloric acid, or combinations thereof.

15. The method of claim 10 wherein complexing the hydrophilic ionomeric polymer comprises complexing the dried coated membrane together with the second microporous support membrane with a complexing agent in situ in a redox flow battery cell.

16. The method of claim 10 wherein the hydrophilic ionomeric polymer comprises a polysaccharide polymer, a poly(acrylic acid) polymer, a poly(methacrylic acid), or combinations thereof.

17. The method of claim 16 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

18. A redox flow battery system, comprising:
at least one rechargeable cell comprising a positive electrolyte, a negative electrolyte, and an ionically conductive thin film composite (TFC) membrane positioned between the positive electrolyte and the negative electrolyte, wherein the TFC membrane comprises a first microporous support membrane, a hydrophilic ionomeric polymer coating layer on a surface of the first microporous support membrane, and a second microporous support membrane on a surface of the hydrophilic ionomeric polymer coating layer opposite the first microporous support membrane, wherein the hydrophilic ionomeric polymer coating layer is ionically conductive.

19. The redox flow battery system of claim 18 wherein the negative electrolyte, the positive electrolyte, or both the negative electrolyte and the positive electrolyte comprises a boric acid additive capable of complexing with a hydrophilic ionomeric polymer on the surface of the microporous support membrane to form a cross-linked hydrophilic ionomeric polymer coating layer.

20. The redox flow battery system of claim 18 wherein the hydrophilic ionomeric polymer coating layer is formed in situ by complexing a hydrophilic ionomeric polymer on the surface of the first microporous support membrane with a complexing agent in the negative electrolyte, the positive electrolyte, or both the negative electrolyte and the positive electrolyte.
